(19) United States
(12) Patent Application Publication
(10) Pub. No.: US 2004/0199383 A1
(43) Pub. Date: Oct. 7, 2004

(54) Speech encoder, speech decoder, speech endoding method, and speech decoding method

(76) Inventors: Yumiko Kato, Osaka (JP); Takahiro Kamai, Kyoto (JP)

Correspondence Address: HARNESS, DICKEY & PIERCE, P.L.C., P.O. BOX 828, BLOOMFIELD HILLS, MI, 48303, US

(21) Appl. No.: 10/490,693

(22) PCT Filed: Nov. 1, 2002
(86) PCT No.: PCT/JP02/11474

(30) Foreign Application Priority Data
Nov. 16, 2001 (JP) 2001-351803

(51) Int. Cl. G10L 19/04

(52) U.S. Cl. 704/219

(57) ABSTRACT

A speech encoder (10) comprises a speech analyzing unit (110), a vocal-tract parameter discontinuous point detecting unit (120), a frame thinning unit (130), and a code generating unit (140). The frame-thinning unit (130) thins every other frames other than the frames including a phoneme boundary or adjoining a phoneme boundary if the frames are in a consonant section or thins one frame including a phoneme boundary or adjoining it one frame adjoining the thinned frame including a phoneme boundary or adjoining it and included in a vowel, syllabic nasal, or long vowel section, one frame including the time point of ½ of the time length of the phoneme section, one frame including a discontinuous point of a vocal-tract parameter, and one frame other than the one immediately after or before the thinned frame including a discontinuous point of a vocal-tract parameter, if the frames are in a vowel, syllabic nasal, or long vowel section.

### TECHNICAL FIELD

The present invention relates to a speech encoder, speech decoder, speech encoding method and speech decoding method. More specifically, the present invention relates to a speech encoder and speech encoding method for estimating vocal tract parameters and sound source parameters from a speech signal based on a predetermined speech generation model to encode the estimated parameters, and to a speech decoder and speech decoding method for applying sound source parameters and vocal tract parameters to the speech generation model to synthesize a speech signal.

### BACKGROUND ART

As for a speech encoding method wherein an input speech is analyzed to extract sound source parameters and vocal tract parameters and encode the extracted parameters, there is the technique of reducing the amount of data of the sound source parameters and the vocal tract parameters. For example, in a method wherein an analysis is performed on every frame of a constant time length, the amount of data is reduced by extending the unit time of a single frame or regularly thinning frames. In this technique, data is uniformly reduced although, in general, the speech waveform or the change in each parameter is different among different portions of the speech. Therefore, the sound quality of decoded speech is poor.

### DISCLOSURE OF THE INVENTION

An objective of the present invention is to provide a speech encoding method and speech encoder with which deterioration of the sound quality of decoded speech is reduced.

According to one aspect of the present invention, a speech encoder comprises a speech analyzing section, a detection section, a thinning section and a code generating section. The speech analyzing section estimates from a speech signal a vocal tract parameter and a sound source parameter for each frame based on a predetermined speech generation model. The detection section detects a discontinuous point in the vocal tract parameter estimated by the speech analyzing section. The thinning section thins frames except for a frame which includes the discontinuous point detected by the detection section. The code generating section encodes a vocal tract parameter and a sound source parameter of a frame obtained after the thinning process of the thinning section and thinning information which represents the number of frames excluded by the thinning section.

In the above speech encoder, frames are thinned by the thinning section except for a frame which includes the discontinuous point in the vocal tract parameter. Herein, “thinning” means excluding some or all of frames which are subjected to a thinning process (i.e., frames other than a frame including a discontinuous point in the vocal tract parameters) from an encoding process performed by the code generating section. Among the frame including the discontinuous point detected by the detection section and frames which are subjected to the thinning process, vocal tract parameters and sound source parameters of frames which are not excluded by the thinning section (herein, these frames are referred to as “frames obtained after the thinning process of the thinning section”) and thinning information which represents the number of frames excluded from the encoding process (frames thinned by the thinning section) are encoded by the code generating section. In this way, the data amount of the encoded data is reduced. Herein, the “discontinuous point in the vocal tract parameters” means a point at which the correspondence between the vocal tract parameters and the formants of speech shifts. The discontinuous point in the vocal tract parameters corresponds to a point where a speech organ is largely moved within a short time period when a speech to be encoded is produced. At this discontinuous point, both the sound source parameters and the vocal tract parameters largely change. Thus, when a frame including a discontinuous point in a vocal tract parameter which largely varies is selected as a subject for a thinning process (i.e., excluded from an encoding process), it is difficult to interpolate this frame such that deterioration of the sound quality of decoded speech is suppressed. In the above speech encoder, the frame including the discontinuous point in the vocal tract parameters is retained (i.e., not excluded from the encoding process), and therefore, deterioration of the sound quality which may occur in the decoding process is reduced.

Preferably, the speech encoder further comprises a determination section. The determination section determines voiced sound and unvoiced sound of the speech signal. The thinning section detects a frame which includes a boundary between the voiced sound and the unvoiced sound of the speech signal based on a determination result of the determination section and thins frames except for the frame which includes the boundary and the frame which includes the discontinuous point detected by the detection section.

Voiced sound is an utterance which is accompanied by vibrations of a vocal cord, and unvoiced sound is an utterance which is not accompanied by vibrations of a vocal cord. A boundary between voiced sound and unvoiced sound is a point where the weight of a model that represents vocal cord vibrations and the weight of a model that represents a noise source in the vocal tract largely change within a short time period. At this boundary, the sound source parameters steeply change. The boundary between voiced sound and unvoiced sound is a boundary of phonemes, at which the vocal tract steeply changes at the time of utterance. In this way, the sound source parameters and vocal tract parameters largely change at the boundary between voiced sound and unvoiced sound. Thus, in the case where a frame including the boundary between voiced sound and unvoiced sound is selected as a subject for a thinning process (i.e., excluded from the thinning process), a steep change in a parameter cannot be reproduced by interpolation in a decoding process, and accordingly, the sound quality may deteriorate in the decoding process. However, in the above speech encoder of the present invention, a frame including a boundary between voiced sound and unvoiced sound is retained (i.e., not excluded from the encoding process), and therefore, deterioration of the sound quality which may occur in the decoding process is reduced.

Preferably, the thinning section thins frames except for the frame which includes the boundary between the voiced sound and the unvoiced sound, one or more frames subsequent to the frame which includes the boundary, and the frame which includes the discontinuous point. The one or more frames subsequent to the frame which includes the boundary correspond to a speech waveform at a point in a 30 msec (millisecond) range from the boundary.

In the above speech encoder, one or more frames subsequent to the frame which includes the boundary is also retained (i.e., not excluded from the encoding process) as well as the frame including the boundary between voiced sound and unvoiced sound, and therefore, deterioration of the sound quality which may occur in the decoding process is reduced as compared with a case where only a frame including the boundary between voiced sound and unvoiced sound is retained.

As for a phoneme having a long time length, the movement of the speech organ is slow in the vicinity of a central part of the time length of the phoneme. That is, a change in both the sound source parameters and the vocal tract parameters is small in the vicinity of the central part of the time length. Thus, frames of this portion are readily reproduced by interpolation even when they are excluded by thinning. Therefore, the thinning process gives only a small effect to the sound quality obtained in the decoding process. The time consumed from the boundary between voiced sound and unvoiced sound to a point of a “stationary” sound state where the variations in the parameters are small is 30 msec or shorter. Thus, if a frame which is more than 30 msec distant from the boundary between voiced sound and unvoiced sound is retained, the compression efficiency is decreased. In the above speech encoder of the present invention, the one or more frames subsequent to the frame which includes the boundary between voiced sound and unvoiced sound correspond to a speech waveform at a point in a 30 msec (millisecond) range from the boundary. Therefore, a decrease in the compression efficiency is prevented.

Preferably, the thinning section detects a frame which includes a phoneme boundary of the speech signal based on phoneme label information about the speech signal and thins frames except for the frame which includes the phoneme boundary and the frame which includes the discontinuous point detected by the detection section.

When speech is emitted, the speech organ is largely moved in the vicinity of a phoneme boundary within a short time period in order to produce respective phonemes. Since the speech is kept emitted while the speech organ is moving, the speech steeply changes in the vicinity of a phoneme boundary. Thus, the sound source parameters and the vocal tract parameters largely change not only at the boundary between voiced sound and unvoiced sound but also a boundary between phonemes (phoneme boundary), such as a boundary between a consonant and a vowel, a boundary between a consonant and a subsequent consonant, a boundary between a vowel and a subsequent vowel, or the like. Therefore, when a frame including a phoneme boundary is selected as a subject for a thinning process (i.e., excluded from an encoding process), a steep change in the parameters cannot be reproduced by interpolation in a decoding process, and accordingly, the sound quality of a decoded speech is poor. However, in the above speech encoder of the present invention, a frame including a phoneme boundary is retained (i.e., not excluded from the encoding process). Therefore, the deterioration in the sound quality which may be caused in the decoding process is reduced.

Preferably, the thinning section thins frames except for the frame which includes the phoneme boundary, one or more frames subsequent to the frame which includes the phoneme boundary, and the frame which includes the discontinuous point. The one or more frames subsequent to the frame which includes the phoneme boundary correspond to a speech waveform at a point in a 30 msec range from the phoneme boundary.

In the above speech encoder, one or more frames subsequent to the frame which includes the phoneme boundary is also retained (i.e., not excluded from the encoding process) as well as the frame including the phoneme boundary, and therefore, deterioration of the sound quality which may occur in the decoding process is reduced as compared with a case where only a frame including the phoneme boundary is retained.

In the case of an average speech speed, the time length of a phoneme is about 130 msec at the most, and many phonemes each have a time length shorter than 100 msec. In the case where frames corresponding to parts of a speech waveform which are 30 msec or more distant from the phoneme boundaries of a phoneme at its start point and end point are all retained (i.e., not excluded from the encoding process), the number of frames that can be excluded by thinning is decreased, and the effect of compression is reduced. In a phoneme having a long time length, the movement of the speech organ is slow in the vicinity of a central part of the time length. That is, the variations in both the sound source parameters and vocal tract parameters are small in the vicinity of the central part of the time length. Thus, even when the frames of this part are excluded by thinning, these frames are readily reproduced by interpolation, and the influence of the thinning on the sound quality which is caused in the decoding process is small. The time consumed from the phoneme boundary to a point of a “stationary” sound state where the variations in the parameters are small is 30 msec or shorter. Thus, if a frame which is more than 30 msec distant from the phoneme boundary is retained, the compression efficiency is decreased. In the above speech encoder, the one or more frames subsequent to the frame which includes the phoneme boundary correspond to a speech waveform at a point in a 30 msec range from the phoneme boundary. Therefore, a decrease in the compression efficiency is prevented.

Preferably, the thinning section thins frames except for the frame which includes the phoneme boundary, the frame which includes the discontinuous point, and a frame which includes a point in the vicinity of a central part of the time length of each phoneme. The point in the vicinity of a central part of the time length of each phoneme is preferably a ½-point of the time length of each phoneme.

When a speech is emitted, the speech organ largely moves within a short time period at a phoneme boundary between a current phoneme and a previous phoneme and then moves slowly to express the characteristics of the current phoneme most typically. Then, the movement of the speech organ gradually becomes larger as the current phoneme is passed toward a next phoneme, and the speech organ steeply moves at a phoneme boundary between the current phoneme and a next phoneme. In vocalization, the above process is continuously performed. Accordingly, a change in the speech is fast in the vicinity of a phoneme boundary but slow in the central part of the phoneme time length. The central part of the phoneme time length expresses the characteristics of the current phoneme most typically. Interpolation of frames in the vicinity of a phoneme boundary cannot reproduce the part of the phoneme which expresses the characteristics of the phoneme, i.e., the central part of the phoneme time length, and accordingly, the sound quality of decoded speech is poor. In the above speech encoder of the present invention, a frame including a ½-point of the time length of each phoneme is retained (i.e., not excluded from the encoding process). Thus, parameters which are supposed to express the characteristics of each phoneme most typically are not excluded by thinning but encoded, whereby the deterioration of the sound quality which may occur in the decoding process is prevented.

Preferably, the thinning section thins frames except for the frame which includes the phoneme boundary, the frame which includes the discontinuous point, and a frame which includes a maximum amplitude point of each phoneme.

In many phonemes, the amplitude is small at the start point and end point of each phoneme but is at its maximum in the central part of the phoneme time length which expresses the characteristics of the phoneme most typically. In the above speech encoder of the present invention, a frame including the maximum amplitude point of each phoneme is retained (i.e., not excluded from the encoding process), parameters which are supposed to express the characteristics of each phoneme most typically are not excluded by thinning but encoded, whereby the deterioration of the sound quality which may occur in the decoding process is prevented.

Preferably, the vocal tract parameter includes a plurality of parameter sets. The plurality of parameter sets represent a vocal tract filter of the speech generation model. The detection section establishes correspondence of parameter sets between adjacent frames by DP matching and detects the discontinuous point based on the established correspondence.

In the above speech encoder, a point where the identity of the vocal tract filter is not maintained between adjacent frames is detected by DP matching as a discontinuous point.

Preferably, the thinning section thins frames except for the frame which includes the discontinuous point and at least one of frames which exist between a frame including a certain discontinuous point and a frame including a discontinuous point next to the certain discontinuous point.

Since the speech sound also varies incessantly at points other than the discontinuous points in the vocal tract parameters, the sound source parameters and vocal tract parameters need to change in accordance with the variation of the speech sound. If all of the frames are excluded by thinning except for a frame including a discontinuous point in the vocal tract parameters, it is difficult to produce the locus of the variation of the speech sound except for the discontinuous point by interpolation in the decoding process. In the above speech encoder of the present invention, at least one of frames which exist between a frame including a certain discontinuous point and a frame including a discontinuous point next to the certain discontinuous point is retained (i.e., not excluded from the encoding process), the locus of the variation of the speech sound except for the discontinuous point is readily produced by interpolation in the decoding process.

According to another aspect of the present invention, a speech decoder is a decoder for synthesizing a speech signal based on the speech generation model using data encoded by the above speech encoder of the present invention, which comprises a detection section, an interpolation section and a sound synthesizing section. The detection section detects based on thinning information included in the encoded data the number of frames excluded by thinning from between a first frame of the encoded data and a second frame which comes next to the first frame. The interpolation section interpolates a sound source parameter and a vocal tract parameter of an excluded frame between the first and second frames based on the number of frames detected by the detection section, a sound source parameter and a vocal tract parameter of the first frame, and a sound source parameter and a vocal tract parameter of the second frame. The sound synthesizing section applies a sound source parameter of the encoded data which is obtained after the interpolation performed by the interpolating section to a sound source model of the speech generation model to generate a sound source signal, constructs a vocal tract filter of the speech generation model based on a vocal tract parameter of the encoded data which is obtained after the interpolation performed by the interpolating section, and subjects the generated sound source signal to the constructed vocal tract filter to generate a speech signal.

According to still another aspect of the present invention, a speech encoding method comprises an estimation step, a detection step, a thinning step and an encoding step. At the estimation step, a vocal tract parameter and a sound source parameter for each frame are estimated from a speech signal based on a predetermined speech generation model. At the detection step, a discontinuous point in the vocal tract parameter estimated at the estimation step is detected. At the thinning step, frames are thinned except for a frame which includes the discontinuous point detected at the detection step. At the encoding step, a vocal tract parameter and a sound source parameter of a frame obtained after the thinning process at the thinning step and thinning information which represents the number of frames excluded at the thinning step are encoded.

Preferably, the above speech encoding method further comprises a determination step. At the determination step, voiced sound and unvoiced sound of the speech signal are determined. At the thinning step, a frame which includes a boundary between the voiced sound and the unvoiced sound of the speech signal is detected based on a determination result of the determination step, and frames are thinned except for the frame which includes the boundary and the frame which includes the discontinuous point detected at the detection step.

Preferably, at the thinning step, frames are thinned except for the frame which includes the boundary between the voiced sound and the unvoiced sound, one or more frames subsequent to the frame which includes the boundary, and the frame which includes the discontinuous point. The one or more frames subsequent to the frame which includes the boundary correspond to a speech waveform at a point in a 30 msec range from the boundary.

Preferably, at the thinning step, a frame which includes a phoneme boundary of the speech signal is detected based on phoneme label information about the speech signal, and frames are thinned except for the frame which includes the phoneme boundary and the frame which includes the discontinuous point detected at the detection step.

Preferably, at the thinning step, frames are thinned except for the frame which includes the phoneme boundary, one or more frames subsequent to the frame which includes the phoneme boundary, and the frame which includes the discontinuous point. The one or more frames subsequent to the frame which includes the phoneme boundary correspond to a speech waveform at a point in a 30 msec range from the phoneme boundary.

Preferably, at the thinning step, frames are thinned except for the frame which includes the phoneme boundary, the frame which includes the discontinuous point, and a frame which includes a point in the vicinity of a central part of the time length of each phoneme. The point in the vicinity of a central part of the time length of each phoneme is preferably a ½-point of the time length of each phoneme.

Preferably, at the thinning step, frames are thinned except for the frame which includes the phoneme boundary, the frame which includes the discontinuous point, and a frame which includes a maximum amplitude point of each phoneme.

Preferably, the vocal tract parameter includes a plurality of parameter sets. The plurality of parameter sets represent a vocal tract filter of the speech generation model. At the detection step, correspondence of parameter sets between adjacent frames is established by DP matching, and the discontinuous point is detected based on the established correspondence.

Preferably, at the thinning step, frames are thinned except for the frame which includes the discontinuous point and at least one of frames which exist between a frame including a certain discontinuous point and a frame including a discontinuous point next to the certain discontinuous point.

According to still another aspect of the present invention, a speech decoding method is a method for synthesizing a speech signal based on the speech generation model using encoded data generated by the above speech encoding method of the present invention. In the speech decoding method, the number of frames excluded by thinning from between a first frame of the encoded data and a second frame which comes next to the first frame is detected based on thinning information included in the encoded data. Then, a sound source parameter and a vocal tract parameter of an excluded frame between the first and second frames are interpolated based on the detected number of frames, a sound source parameter and a vocal tract parameter of the first frame, and a sound source parameter and a vocal tract parameter of the second frame. Then, sound source parameters of respective frames of the encoded data which are obtained after the interpolation are applied to a sound source model of the speech generation model to generate a sound source signal. The vocal tract filter of the speech generation model is constructed based on vocal tract parameters of the respective frames. Then, the generated sound source signal is subjected to the constructed vocal tract filter to generate a speech signal.

### BRIEF DESCRIPTION OF DRAWINGS

FIG. 1 is a block diagram showing the structure of a speech encoder and speech decoder according to embodiment 1 of the present invention.

FIG. 2 is a flowchart which illustrates the procedure of a process performed by the speech encoder shown in FIG. 1.

FIG. 3 shows parameter sets of the vocal tract parameters of two adjacent frames.

FIG. 4 shows a lattice wherein the parameter sets of frame A are allocated over the horizontal axis and the parameter sets of frame B are allocated over the vertical axis.

FIG. 5 shows a lattice wherein all the formants are connected such that formants having the same number are connected to each other.

FIG. 6 shows a lattice including unconnected formants.

FIG. 7 shows a restriction imposed on a move.

FIG. 8 shows lattice points which can be taken under the restriction shown in FIG. 7.

FIG. 9 is a flowchart which illustrates the procedure of a path search process.

FIG. 10 shows an example of the cost calculated through the path search process.

FIG. 11 shows an example where path B is selected.

FIG. 12 shows an obtained optimum path.

FIG. 13 shows formants connected according to the optimum path.

FIG. 14 shows how to thin frames.

FIG. 15 is a flowchart which illustrates the procedure of a process performed by the speech decoder shown in FIG. 1.

FIG. 16 is a block diagram showing the structure of a speech encoder according to embodiment 2 of the present invention.

FIG. 17 is a flowchart which illustrates the procedure of a process performed by the speech encoder shown in FIG. 16.

FIG. 18 shows how to thin frames.

### BEST MODE FOR CARRYING OUT THE INVENTION

Hereinafter, embodiments of the present invention will be described in detail with reference to the drawings. In the drawings, like elements are denoted by like reference numerals, and descriptions thereof are not repeated.

### EMBODIMENT 1

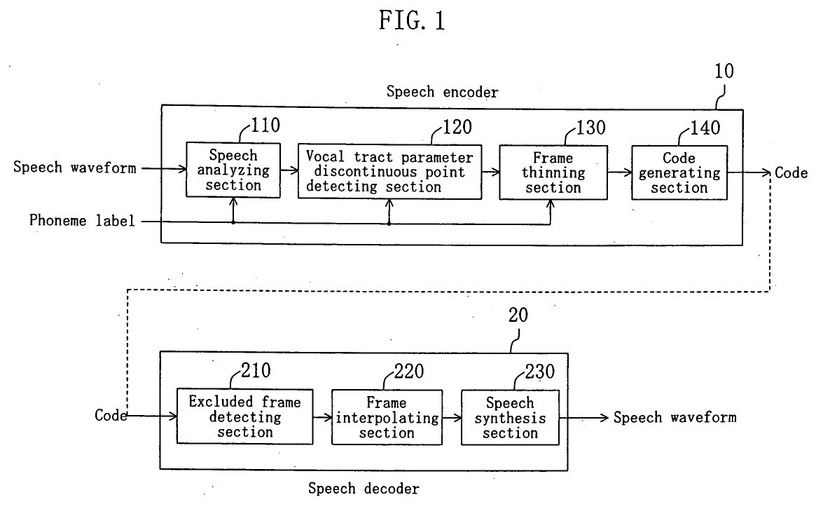

FIG. 1 is a block diagram showing the structure of a speech encoder and speech decoder according to embodiment 1 of the present invention.

<Structure of Speech Encoder 10>

A speech encoder 10 shown in FIG. 1 includes a speech analyzing section 110, a vocal tract parameter discontinuous point detecting section 120, a frame thinning section 130 and a code generating section 140. The speech analyzing section 110 divides an input speech waveform (speech signal) into frames each of which has a predetermined time width and estimates sound source parameters and vocal tract parameters for each frame based on a predetermined speech generation model. The vocal tract parameter discontinuous point detecting section 120 establishes between adjacent frames the correspondence of parameter sets of the vocal tract parameters (formant center frequency, formant bandwidth) extracted by the speech analyzing section 110 by using a DP matching method and detects a discontinuous point in the vocal tract parameters based on the established correspondence. The frame thinning section 130 adaptively thins the analyzed frames according to a phoneme label. The code generating section 140 multiplexes vocal tract parameters and sound source parameters of the frames which are obtained after the thinning by the frame thinning section 130 with the number of frames excluded by the frame thinning section 130 (thinning information) to generate a code (encoded data).

<Structure of Speech Decoder 20>

A speech decoder 20 shown in FIG. 1 includes an excluded frame detecting section 210, a frame interpolating section 220 and a speech synthesis section 230. The excluded frame detecting section 210 separates the thinning information from the code generated by the speech encoder 10 to specify the range of the excluded frames. The frame interpolating section 220 interpolates parameters of the frames included in the range specified by the frame detecting section 210 using the parameters of the frames immediately before and immediately after the specified range. The speech synthesis section 230 applies the sound source parameters and the vocal tract parameters of each frame obtained after the interpolation to a predetermined speech generation model to synthesize a speech waveform (speech signal).

<Operation of Speech Encoder 10>

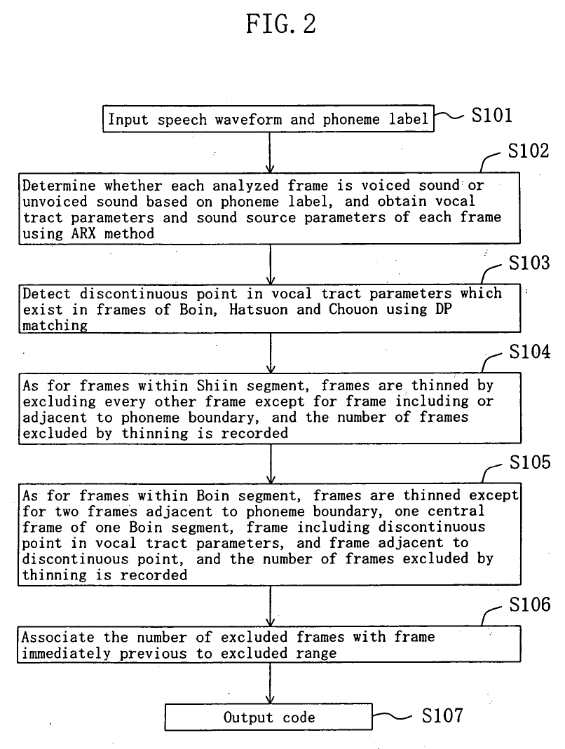

Next, an operation of the speech encoder 10 having the above structure is described with reference to FIG. 2.

[Step S101]

In the first place, a speech waveform (speech signal) and a phoneme label for the speech waveform are input to the speech encoder 10.

[Step S102]

The speech analyzing section 110 divides the input speech waveform into frames such that each frame has a predetermined time width and determines whether each analyzed frame is within a segment of voiced sound or unvoiced sound based on the phoneme label. The speech analyzing section 110 then estimates vocal tract parameters and sound source parameters from the speech signal based on the predetermined speech generation model. Herein, as for the frames in the voiced sound segment, the sound source parameters and the vocal tract parameters are simultaneously estimated using as the convergence condition an error in the drive timing of a sound source model designed based on the ARX (auto-regressive with ex-ogenous input) speech generation model as described in “ARX speech analysis/synthesis method with spectrum correction and evaluation thereof” (Proceedings of the 2000 Spring Meeting of the Acoustical Society of Japan, pp. 329-330), whereas as for the frames in the unvoiced sound segment, the vocal tract parameters are estimated using random noise as a sound source. In this way, the sound source parameters and the vocal tract parameters of each analyzed frame are extracted. The sound source parameters include the amplitude, the opening ratio of a vocal tract, the fundamental frequency, etc. The vocal tract parameters include the formant center frequency and the formant bandwidth. The formant center frequency and the formant bandwidth for a certain formant constitute one parameter set. In general, a single frame includes a plurality of formants. Thus, the vocal tract parameters of each frame include a plurality of parameter sets. Each parameter set expresses a vocal tract filter of the speech generation model.

[Step S103]

Then, the vocal tract parameter discontinuous point detecting section 120 refers to the phoneme label to detect a discontinuous point in the vocal tract parameters which exist in the frames of Boin [vowel], Hatsuon [syllabic n] and Chouon [long vowel]. The “discontinuous point” in a vocal tract parameter means a point where the correspondence between the vocal tract parameter and the formants of speech shifts. The vocal tract parameter discontinuous point detecting section 120 establishes between adjacent frames the correspondence of parameter sets of the vocal tract parameters (formant center frequency, formant bandwidth) extracted by the speech analyzing section 110 by using a DP matching method and detects a discontinuous point in the vocal tract parameters based on the established correspondence. The connection cost is determined by performing the DP matching on the parameter sets of the adjacent frames using a formant intensity which is obtained based on the formant center frequency and the formant bandwidth, so as to detect a parameter set which has no partner parameter set corresponding thereto, as described in “Improvement of source/formant-type speech synthesizing method” (Proceedings of the 2000 Autumn Meeting of the Acoustical Society of Japan, pp. 231-232).

The thus-detected parameter set is considered as a discontinuous point in the vocal tract parameters. Hereinafter, the above operation is specifically described.

[Detection of a Discontinuous Point in the Vocal Tract Parameters using DP Matching]

Herein, a distance scale consisting of the connection cost of expression 1 and the non-connection cost of expression 2 is used.

d_{c}(F(n),F(n+1))=α|F₁(n)−F_{f}(n+1)|+β|F₁(n)−Fᵢ(n+1)| Expression 1

$$\begin{matrix}{d}_{c} ( F ( k ) ) = α \vert {F}_{f} ( k ) - {F}_{f} ( k ) \vert + β \vert {F}_{i} ( k ) - ϵ \vert \\ = β \vert {F}_{i} ( k ) - ϵ \vert\end{matrix} \qquad Expression 2$$

In the above expressions, F_{f} is the formant center frequency, and Fᵢ is the formant intensity. The formant intensity Fᵢ is defined by a difference between the maximum level and minimum level of the formant spectrum as shown in expression 3.

$${F}_{i} ( n ) \{ \begin{matrix}20 {log}_{10} ( \frac{1 + {ⅇ}^{- π {F}_{b} ( n ) / {F}_{s}}}{1 - {ⅇ}^{- π {F}_{b} ( n ) / {F}_{s}}} ) , & if formant \\ 20 {log}_{10} ( \frac{1 - {ⅇ}^{- π {F}_{b} ( n ) / {F}_{s}}}{1 + {ⅇ}^{- π {F}_{b} ( n ) / {F}_{s}}} ) , & if anti \text{-} formant\end{matrix} \qquad Expression 3$$

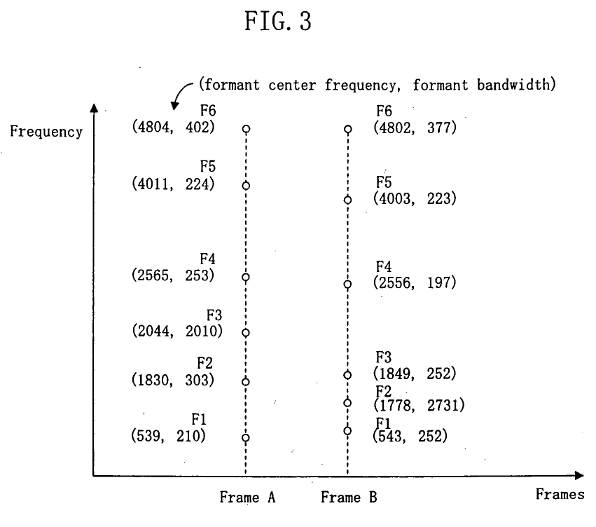

FIG. 3 illustrates parameter sets (formant center frequency, formant bandwidth) which include formants F1-F6 of two adjacent frames. In FIG. 3, the horizontal axis represents a frame number, and the vertical axis represents the frequency. The value of each parameter set is expressed in the form of “(formant center frequency, formant bandwidth)”. Each of the two frames (frame A and frame B) includes 6 formants F1-F6. These formants are numbered as F1, F2, . . . in increasing order of the formant center frequency. Between two parameter sets each including 6 formants, the formants having the same number are generally connected (made correspondent) to each other between frame A and frame B. However, the formant center frequencies of formant F2 and formant F3 of frame B are close to each other and are both close to the formant center frequency of formant F2 of frame A. Further, the value of the formant bandwidth of formant F2 of frame B is very large. A formant having a large formant bandwidth has a low intensity and is considered to be just vanishing or emerging. Thus, formant F2 of frame B is recognized as an emerging formant and should not be connected (made correspondent) to formant F2 of frame A. Formant F2 of frame A should be connected (made correspondent) to formant F3 of frame B. DP matching is used for automatically making such a determination.

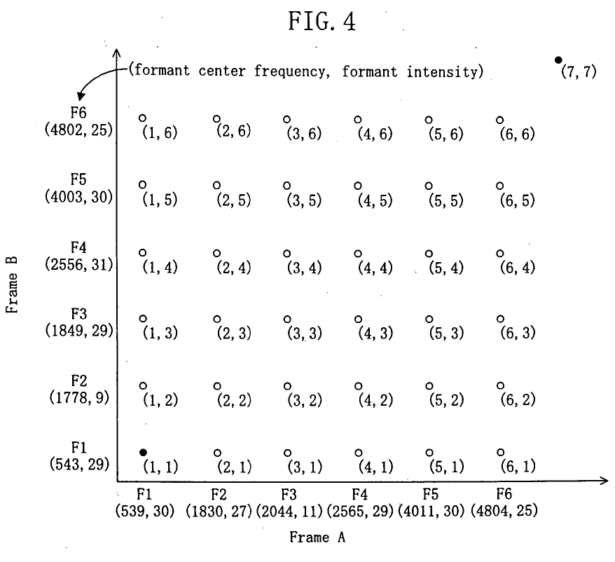

FIG. 4 shows a map wherein the formants of frame A are allocated over the horizontal axis, the formants of frame B are allocated over the vertical axis, and points arranged in the form of a lattice are shown with the coordinates (1, 1), (1, 2), . . . . In FIG. 4, the value of each formant is expressed in the form of “(formant center frequency, formant intensity)”. The formant intensity is a value obtained by converting a formant bandwidth based on expression 3.

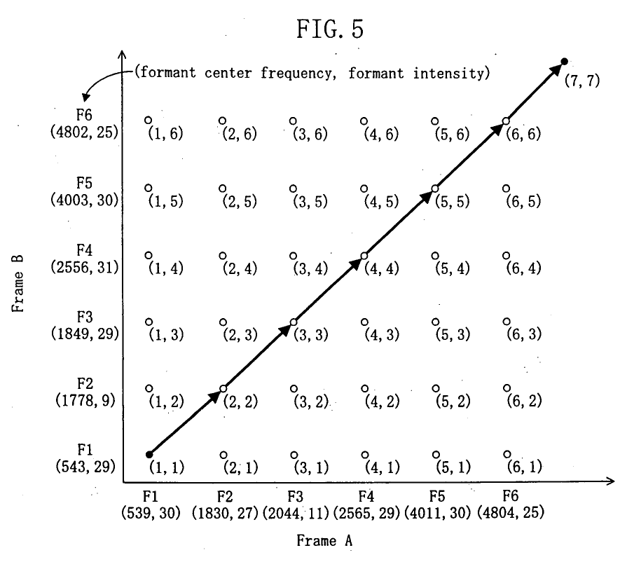

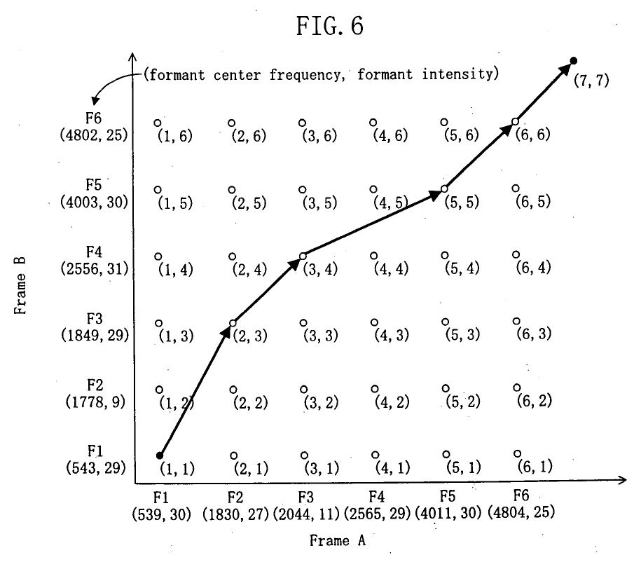

Since each of the two frames has 6 formants, there are 36 lattice points from (1, 1) to (6, 6), but the map of FIG. 4 includes an additional point (7, 7). The lattice points are referred to from point (1, 1) to point (7, 7). For example, as shown in FIG. 5, a path proceeding through (1, 1), (2, 2), (3, 3), (4, 4), (5, 5), (6, 6) and (7, 7) is considered. Point (1, 1) corresponds to formant F1 of frame A and formant F1 of frame B. This rule applies to point (2, 2) and the subsequent lattice points. Thus, when this path is taken, all 6 formants F1-F6 are connected (made correspondent) to the formants of the same number, respectively. However, it may be possible that, for example, a path is taken through (1, 1), (2, 3), (3, 4), (5, 5), (6, 6), and (7, 7) as shown in FIG. 6. In this case, formant F2 of frame A is connected (made correspondent) to formant F3 of frame B, and formant F3 of frame A is connected (made correspondent) to formant F4 of frame B. Formant F4 of frame A and formant F2 of frame B have no partner formant to be connected (made correspondent) to. Formant F4 of frame A is recognized as a vanishing formant, and formant F2 of frame B is recognized as an emerging formant. In this way, the connection (correspondence) of the formants is determined according to the selection of path.

The selection of path is achieved by a method such that the distance cost for the formant center frequency and the formant bandwidth and the cost incurred by a move from a lattice point to another lattice point are reduced.

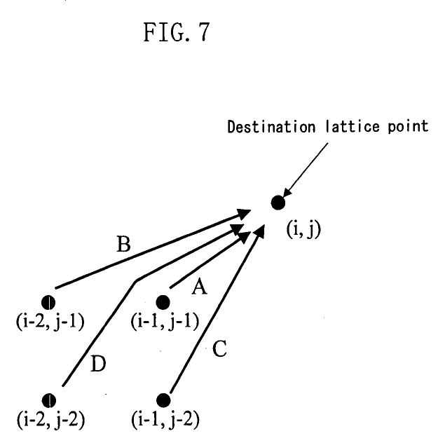

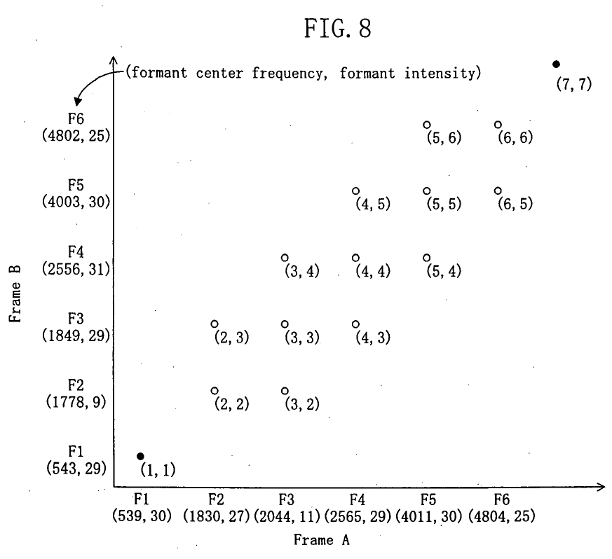

In the first place, a restriction shown in FIG. 7 is placed on the move. That is, the move to point (i, j) can be made only from 4 points, (i-1, j-1), (i-2, j-1), (i-1, j-2), (i-2, j-2). The move from (i-1, j-1) is referred to as move A, the move from (i-2, j-1) is referred to as move B, the move from (i-1, j-2) is referred to as move C, and the move from (i-2, j-2) is referred to as move D. With this restriction, it is clear that lattice points which can be taken in the move from (1, 1) to (7, 7) are limited to the lattice points shown in FIG. 8.

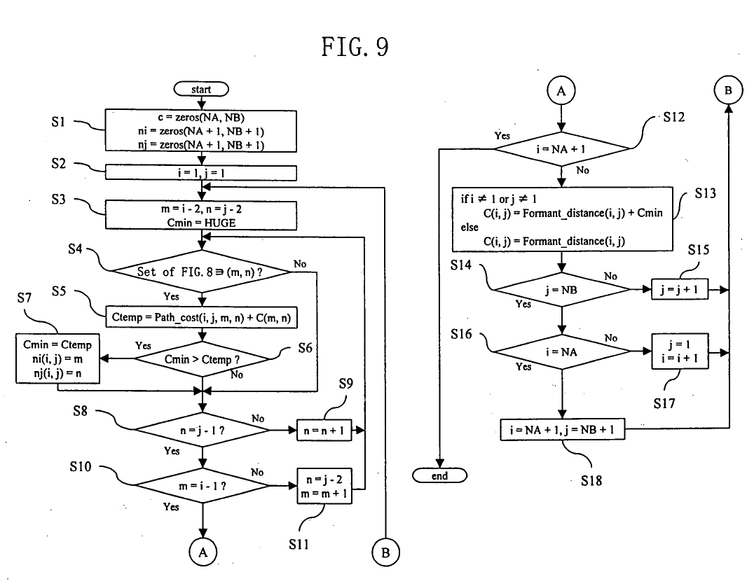

Hereinafter, a procedure of path search is described with reference to FIG. 9.

<<Step S1>>

The number of formants in frame A and frame B are NA and NB, respectively. Array C having a size of NA×NB and arrays ni and nj each having a size of (NA+1)×(NB+1) are prepared, and all the elements of these arrays are initialized with 0. Element C (i, j) of array C is used for storing the accumulation cost of point (i, j). Element ni (i, j) of array ni and element nj (i, j) of array nj are used for storing a path which enables a move to point (i, j) with the minimum accumulation cost, i.e., the optimum path to point (i, j). Assuming that point (m, n) existing on the optimum path to point (i, j) is immediately previous to point (i, j), ni (i, j)=m and nj (i, j)=n.

<<Step S2>>

The accumulation cost and the optimum path are calculated for all of the possible lattice points (see FIG. 8). The counters i and j are each initialized with 1. Herein, “i” and “j” are used as indices of frame A and frame B, respectively.

<<Step S3>>

The cost is calculated for each of the 4 points (m, n) from which the move to point (i, j) is possible (see FIG. 7). Counters m and n are prepared and initialized such that m=i-2 and n=j-2. Further, Cmin is prepared for obtaining the minimum accumulation cost, and a largest possible value is set in Cmin.

<<Step S4>>

Point (m, n) is not included in the set of possible lattice points shown in FIG. 8 (No), the process proceeds to step S8. If included (Yes), the process proceeds to step S5.

<<Step S5>>

Ctemp is prepared for temporarily storing the accumulation cost, in which the sum of the path cost from point (m, n) to point (i, j) and the accumulation cost of point (m, n) is stored.

<<Step S6>>

If Ctemp is smaller than Cmin (Yes), the process proceeds to step S7. If not (No), the process proceeds to step S8.

<<Step S7>>

Cmin is substituted with Ctemp, m is stored in element ni (i, j), and n is stored in element nj (i, j). Element ni (i, j) stores the frame-A axis coordinate of a point from which a move to point (i, j) is made with the minimum accumulation cost. Element nj (i, j) stores the frame-B axis coordinate of this point.

<<Step S8>>

If n=j-1 (Yes), the process proceeds to step S10. If not (No), the process proceeds to step S9.

<<Step S9>>

The coordinate n is incremented by 1, and the process returns to step S4.

<<Step S10>>

If m=i-1 (Yes), the process proceeds to step S12. If not (No), the process proceeds to step S11.

<<Step S11>>

The coordinate n is reset to j-2, the coordinate m is incremented by 1, and the process returns to step S4.

<<Step S12>>

If the coordinate i has reached NA+1 (Yes), the process is ended. If not (No), the process proceeds to step S13.

<<Step S13>>

The accumulation cost is stored in element C (i, j). That is, the sum of the formant distance at point (i, j) (the value obtained by expression 1) and Cmin is stored in element C (i, j). It should be noted that point (1, 1) is the start point of the path and therefore has no path cost. Thus, as for point (1, 1), only the formant distance is stored.

<<Step S14>>

If the coordinate j has reached NB (Yes), the process proceeds to step S16. If not (No), the process proceeds to step S15.

<<Step S15>>

The coordinate j is incremented by 1, and the process returns to step S3.

<<Step S16>>

If the coordinate i has reached NA (Yes), the process proceeds to step S18. If not (No), the process proceeds to step S17.

<<Step S17>>

The coordinate j is reset to 1, the coordinate i is incremented by 1, and the process returns to step S3.

<<Step S18>>

In the last, the point from which the move to the end point (NA+1, NB+1) is possible with the minimum accumulation cost is determined. The coordinates i and j are set such that i=NA+1 and j=NB+1, and the process returns to step S3.

The calculation of the path cost is performed as follows. There are 4 permissible paths, i.e., path A, path B, path C and path D as shown in FIG. 7. The i-th formant of frame A is expressed as FA(i), and the j-th formant of frame B is expressed as FB(j). In the case of path A, FA(i-1) and FA(i) are connected (made correspondent) to FB(j-1) and FB(j), respectively, and no formant is left alone without a partner formant to be connected (made correspondent) to. Thus, the path cost (in other words, “disconnection cost”) is 0. In the case of path B, FA(i-1) has no partner formant to be connected (made correspondent) to. In such a case, the path cost is calculated by substituting the formant intensity of FA(i-1) into expression 2. In the case of path C, FB(j-1) has no partner formant to be connected (made correspondent) to. Thus, the path cost is calculated by substituting the intensity of FB(j-1) into expression 2. In the case of path D, FA(i-1) and FB(j-1) have no partner formant to be connected (made correspondent) to. In this case, the path cost is the sum of the value calculated by substituting the intensity of FA(i-1) into expression 2 and the value calculated by substituting the intensity of FB(j-1) into expression 2. In this way, the actual cost is obtained by such a calculation.

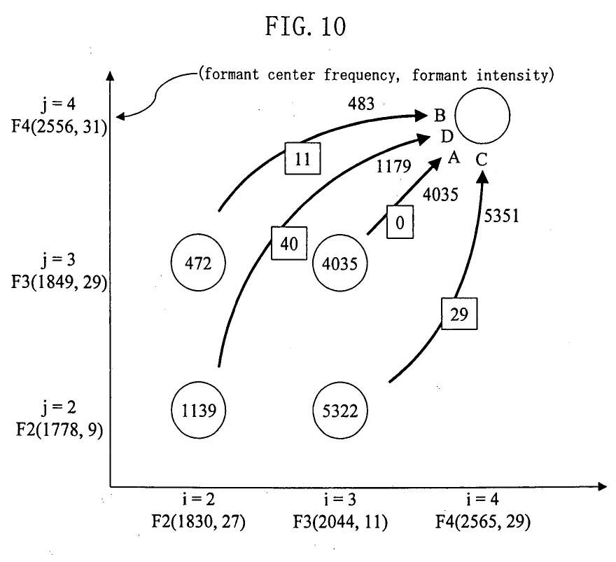

FIG. 10 shows point (i, j) and the 4 points from which the move to point (i, j) is possible, (i-1, j-1), (i-2, j-1), (i-1,j-2), and (i-2, j-2). Arrows illustrate the move from the 4 points to point (i, j). At the tips of the arrows, the names of the paths shown in FIG. 7, A, B, C and D, are shown. In each of circles which represent the 4 points, the accumulation cost at each of the 4 points is shown. The number in a box shown in the middle of the arrow of each path is the path cost. For example, the path cost of path B is calculated based on expression 2 using the intensity of formant F3 of frame A, which is left unconnected (not made correspondent) to any partner formant as a result of selection of path B, thereby resulting in 11.

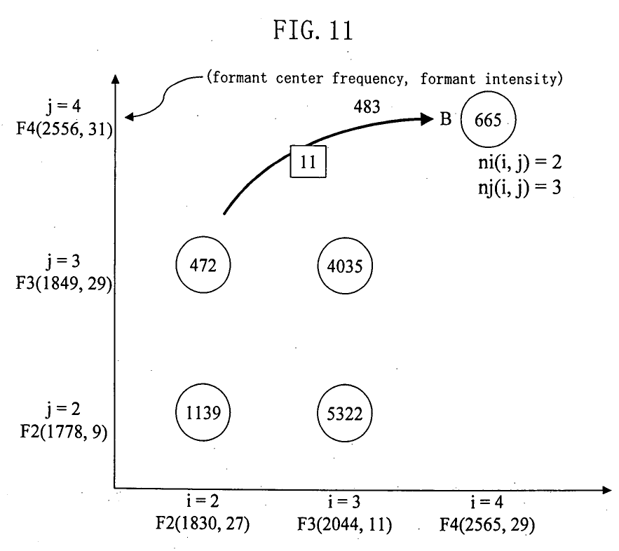

The accumulation cost incurred when point (i, j) is reached through each of the 4 paths (Ctemp calculated at step S5) is shown in the vicinity of the head of the arrow of each path. That is, it is the value obtained by adding the path cost incurred by the move to the accumulation cost at the start point of the move. The accumulation cost is 4035 when path A is taken, 483 when path B is taken, 5351 when path C is taken, and 1179 when path D is taken. From these results, the path which incurs the minimum accumulation cost, i.e., path B, is selected (Step S7 ). Selection of path B is shown in FIG. 11. As a result of selection of path B, the i-axis coordinate value of the start point of path B is stored in element ni (i, j), and the j-axis coordinate value of the start point of path B is stored in element nj (i, j). Further, the accumulation cost of 665, which is obtained by adding the formant distance at point (i, j) calculated based on expression 1 (182) to the accumulation cost incurred by path B (483), is registered at point (i, j) (Step S13).

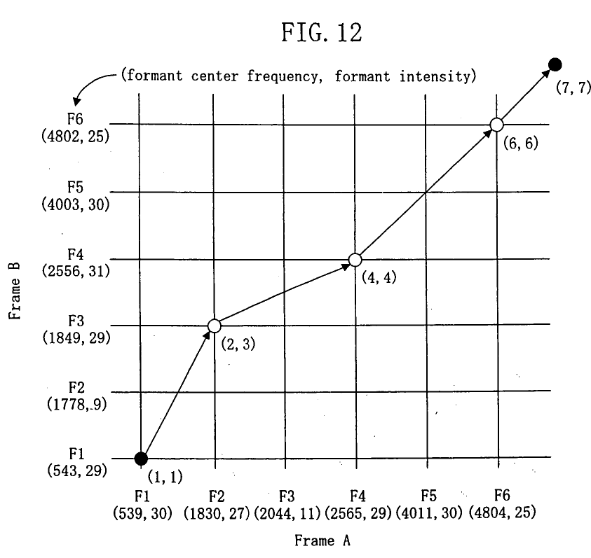

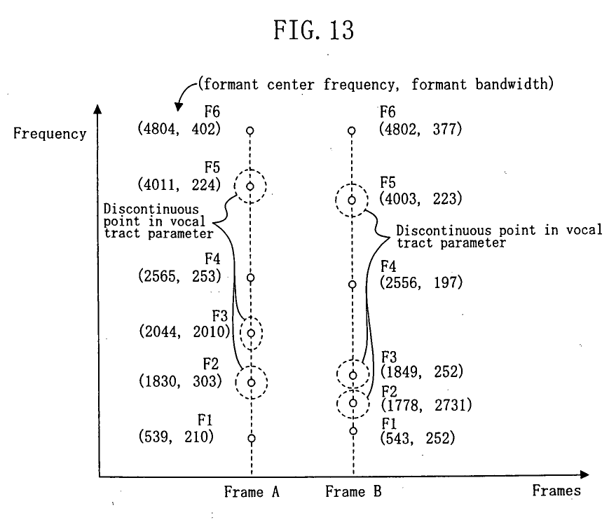

In this way, the optimum path is sequentially determined by calculating the cost. This process is repeated from point (1, 1) up to point (NA+1, NB+1). After that, the optimum path from point (1, 1) to point (NA+1, NB+1) is determined by tracing arrays ni and nj in a reverse direction. The determined optimum path is shown in FIG. 12. FIG. 13 shows connection (correspondence) of the formants (parameter sets) illustrated in FIG. 3, which is determined in view of the optimum path of FIG. 12. Formant F1 of frame A is connected (made correspondent) to formant F1 of frame B, formant F4 of frame A is connected (made correspondent) to formant F4 of frame B, and formant F6 of frame A is connected (made correspondent) to formant F6 of frame B. On the other hand, formants F2, F3 and F5 of frame A and formants F2, F3 and F5 of frame B have no partner formant to be connected (made correspondent) to. These unconnected formants are detected as discontinuous points in the vocal tract parameters. Thus, frame A and frame B are frames including discontinuous points in the vocal tract parameters.

[Step S104]

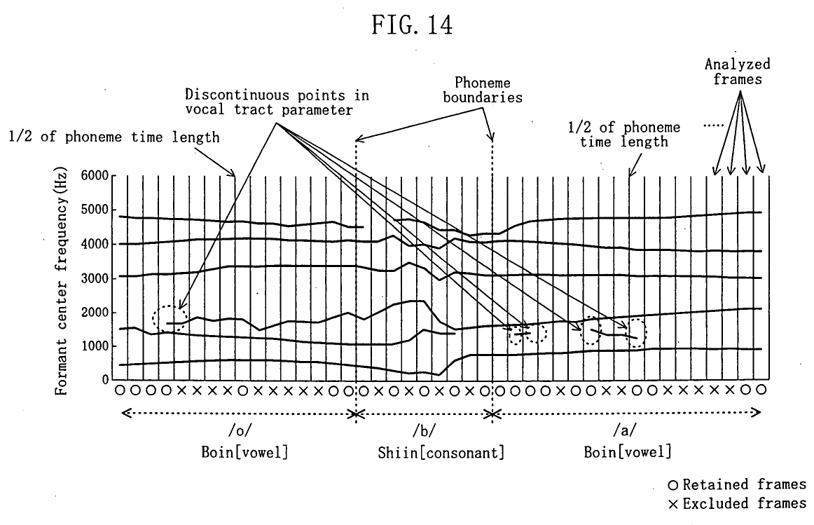

Then, the frame thinning section 130 refers to the phoneme label. If frames are within a Shiin [consonant] segment, the frames are thinned by excluding every other frame from the encoding process performed by the code generating section 140 except for a frame including or adjacent to a phoneme boundary as shown in Shiin [consonant] segment /b/ of FIG. 14. The number of frames excluded by thinning, i.e., 1, is stored so as to be associated with a frame immediately previous to the excluded frame (a frame which is to be subjected to the encoding process performed by the code generating section 140 ). In FIG. 14, a frame excluded from the encoding process performed by the code generating section 140 (“excluded frame”) is denoted by “x”, and a frame which is to be subjected to the encoding process performed by the code generating section 140 (“retained frame”) is denoted by “◯”.

[Step S105]

If the phoneme label referred to by the frame thinning section 130 indicates that frames are within a segment of Boin [vowel], Hatsuon [syllabic n] or Chouon [long vowel], the frames are thinned except for one frame including or adjacent to a phoneme boundary, one frame within the segment of Boin, Hatsuon or Chouon which is adjacent to the frame including or adjacent to the phoneme boundary, one frame including the ½-point (midpoint) of the time length of the phoneme segment, one frame including a discontinuous point in the vocal tract parameters which has been extracted at step S103, and one frame immediately previous or immediately subsequent to the frame including the discontinuous point, as shown in the vowel segments of FIG. 14. The number of excluded frames is stored so as to be associated with a retained frame immediately previous to the excluded range (a segment where excluded frames consecutively exist).

[Step S106]

Then, the code generating section 140 associates a retained frame immediately previous to the excluded range and the number of excluded frames in the excluded range (thinning information) with each other.

[Step S107]

The code generating section 140 encodes the thinning information and the sound source parameters and the vocal tract parameters of the retained frames to generate codes.

As described above, the speech encoder 10 shown in FIG. 1 adaptively performs thinning of frames according to the state of speech in each frame in order to perform recording or transfer of data of a compressed data amount.

<Operation of Speech Decoder 20>

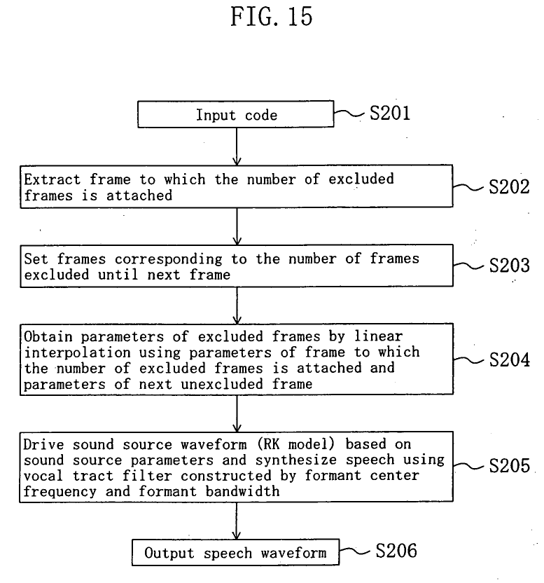

An operation of the speech decoder 20 shown in FIG. 1 is described with reference to FIG. 15.

[Step S201]

In the first place, a code generated by the speech encoder 10 is input to the excluded frame detecting section 210.

[Step S202]

Then, the excluded frame detecting section 210 extracts from the input code a frame having the thinning information attached thereto.

[Step S203]

Then, the frame interpolating section 220 sets a frame(s) corresponding to the number of excluded frames between the frame having the thinning information which has been extracted at step S202 and a frame next to the frame having the thinning information.

[Step S204]

The frame interpolating section 220 performs a linear interpolation using the vocal tract parameters and the sound source parameters of the retained frame immediately previous to the excluded range (the frame having the thinning information) and the vocal tract parameters and the sound source parameters of a frame immediately subsequent to the excluded range (a frame in the code which is recorded immediately after the frame having the thinning information), thereby obtaining the vocal tract parameters and the sound source parameters of a frame(s) of the excluded range (frame(s) set at step S203 ).

[Step S205]

Then, the speech synthesis section 230 applies the vocal tract parameters and the sound source parameters interpolated at step S204 and the vocal tract parameters and the sound source parameters of the retained frames to a predetermined speech generation model in order to synthesize a speech. For example, as described in “ARX speech analysis/synthesis method with spectrum correction and evaluation thereof” (Proceedings of the 2000 Spring Meeting of the Acoustical Society of Japan, pp. 329-330), a sound source waveform which is based on the Rosenberg-Klatt (RK) model is driven based on the sound source parameters, a vocal tract filter is constructed based on the formant center frequency and the formant bandwidth, and the driven sound source waveform is subjected to the vocal tract filter to synthesize a speech.

[Step S206]

The speech synthesis section 230 outputs the speech waveform synthesized at step S205.

As described above, the speech decoder 20 shown in FIG. 1 interpolates frames excluded by the speech encoder 10 and synthesizes a speech from the sound source parameters and the vocal tract parameters.

<Effects>

In the speech encoder 10 according to embodiment 1 of the present invention, when frames are in a Shiin [consonant] segment, a frame including a phoneme boundary or a frame adjacent to a phoneme boundary is selected as a retained frame. When frames are within a segment of Boin [vowel], Hatsuon [syllabic n] or Chouon [long vowel], one frame including or adjacent to a phoneme boundary, one frame within the segment of Boin, Hatsuon or Chouon which is adjacent to the frame including or adjacent to the phoneme boundary, one frame including the ½-point of the time length of the phoneme segment, one frame including a discontinuous point in the vocal tract parameters, and one frame immediately previous or immediately subsequent to the frame including the discontinuous point are selected as retained frames. Thus, it is possible to reduce the deterioration in quality of a synthesized speech which may be caused in speech decoding.

<Variations>

It should be noted that the vocal tract parameter discontinuous point detecting section 120 herein extracts a discontinuous point in the vocal tract parameters using DP matching but may extract such a discontinuous point based on the variation of the formant center frequency as will be described in embodiment 2.

Herein, among frames within the segment of Boin [vowel], Hatsuon [syllabic n] or Chouon [long vowel], two frames adjacent to a phoneme boundary (one frame including or adjacent to a phoneme boundary and one frame within the segment of Boin, Hatsuon or Chouon which is adjacent to the frame including or adjacent to the phoneme boundary) are selected as retained frames. However, any other number of frames may be selected as retained frames so long as they correspond to a speech waveform at a time within a 30 msec range from the phoneme boundary.

Although one frame including the ½-point of the time length of the phoneme segment of Boin, Hatsuon or Chouon is herein selected as a retained frame, one frame including the 1/3 -point of the time length of the phoneme segment of Boin, Hatsuon or Chouon may be selected instead as a retained frame.

Although one frame including the ½-point of the time length of the segment of Boin, Hatsuon or Chouon is selected as a retained frame, a plurality of frames (e.g., two or three frames) subsequent to the frame including the ½-point may be additionally selected as retained frames.

Although one frame including the ½-point of the time length of the phoneme segment of Boin, Hatsuon or Chouon is selected as a retained frame, one frame including the maximum amplitude point in the phoneme segment of Boin, Hatsuon or Chouon may be selected instead as a retained frame.

Although every other frames are excluded by thinning in a Shiin [consonant] segment, any other number of frames may be excluded so long as an interval between retained frames is 20 msec or smaller.

Although phoneme label information corresponding to a speech waveform is herein input, the phoneme label information may be generated by automatic labeling before speech analysis.

### EMBODIMENT 2

<Structure of Speech Encoder>

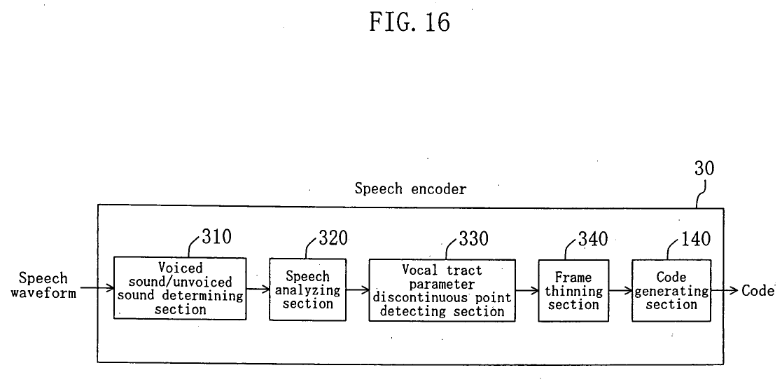

FIG. 16 is a block diagram showing the structure of a speech encoder according to embodiment 2 of the present invention. The speech encoder 30 shown in FIG. 16 includes a voiced sound/unvoiced sound determining section 310, a speech analyzing section 320, a vocal tract parameter discontinuous point detecting section 330, a frame thinning section 340 and a code generating section 140.

The voiced sound/unvoiced sound determining section 310 divides an input speech waveform (speech signal) to frames each having a certain time width and determines whether the speech is voiced sound or unvoiced sound for each frame. The speech analyzing section 320 extracts sound source parameters and vocal tract parameters from the speech waveform for each frame based on the determination of the voiced sound/unvoiced sound determining section 310 as to whether it is voiced sound or unvoiced sound. The vocal tract parameter discontinuous point detecting section 330 detects a discontinuous point in the vocal tract parameters based on the variation of the formant center frequency which is one of the vocal tract parameters extracted by the speech analyzing section 320. The frame thinning section 340 adaptively thins frames according to the determination of the voiced sound/unvoiced sound determining section 310 as to whether it is voiced sound or unvoiced sound. The code generating section 140 multiplexes the vocal tract parameters and the sound source parameters of the frames retained after the thinning by the frame thinning section 340 (retained frames) with the number of frames excluded by the frame thinning section 340 (thinning information) to generate a code (encoded data).

<Operation of Speech Encoder>

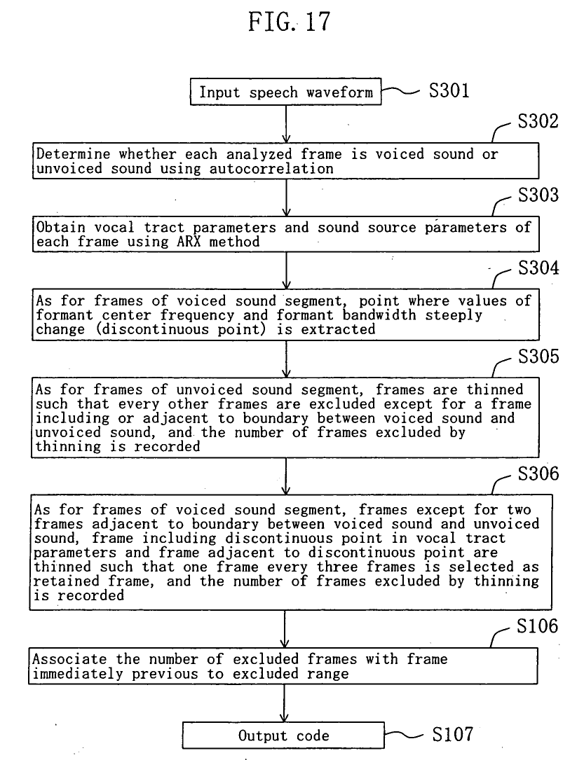

Next, an operation of the speech encoder 30 having the above structure is described with reference to FIG. 17.

[Step S301]

In the first place, a speech waveform is input to the voiced sound/unvoiced sound determining section 310.

[Step S302]

Then, the voiced sound/unvoiced sound determining section 310 determines voiced parts and unvoiced parts of the input speech using autocorrelation, thereby determining whether the speech of each analyzed frame is voiced sound or unvoiced sound.

[Step S303]

As for the frame that has been determined to be voiced sound at step S302, the speech analyzing section 320 then simultaneously estimates the sound source parameters and the vocal tract parameters using as the convergence condition an error in the drive timing of a sound source model designed based on the ARX speech generation model as described in, for example, “ARX speech analysis/synthesis method with spectrum correction and evaluation thereof” (Proceedings of the 2000 Spring Meeting of the Acoustical Society of Japan, pp. 329-330). As for the frame that has been determined to be unvoiced sound at step S302, the speech analyzing section 320 estimates the vocal tract parameters using random noise as a sound source. In this way, the sound source parameters and the vocal tract parameters of each analyzed frame are extracted.

[Step S304]

Then, as for a series of frames that have been determined to be voiced sound at step S302, the vocal tract parameter discontinuous point detecting section 330 compares a plurality of formant center frequencies included in the vocal tract parameters of each frame with a plurality of formant center frequencies included in the vocal tract parameters of a frame immediately previous to the frame. The vocal tract parameter discontinuous point detecting section 330 compares corresponding formant center frequencies between these frames. Then, the vocal tract parameter discontinuous point detecting section 330 extracts, as a discontinuous point, a point where the difference in any formant center frequency is equal to or greater than a predetermined value.

[Step S305]

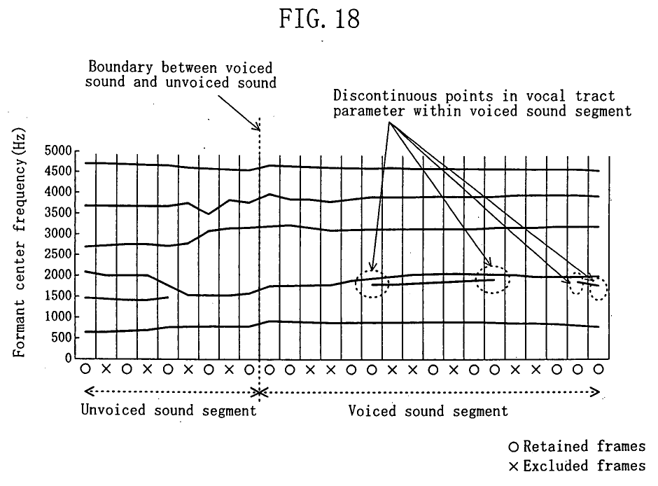

Then, as for a series of frames that have been determined to be unvoiced sound at step S302, the frame thinning section 340 excludes every other frames by thinning (excludes every other frames from the encoding process performed by the code generating section 140) except for a frame including or adjacent to a boundary between voiced sound and unvoiced sound as shown in an unvoiced sound segment of FIG. 18. The frame thinning section 340 stores the number of excluded frames, i.e., 1, so as to be associated with a frame immediately previous to the excluded frame (a frame which is to be subjected to the encoding process performed by the code generating section 140 ). In FIG. 18, a frame excluded from the encoding process performed by the code generating section 140 (“excluded frame”) is denoted by “x”, and a frame which is to be subjected to the encoding process performed by the code generating section 140 (“retained frame”) is denoted by “◯”.

[Step S306]

Then, as for a series of frames that have been determined to be voiced sound at step S302, the frame thinning section 340 selects, as retained frames, one frame including or adjacent to a boundary between voiced sound and unvoiced sound, one frame within a voiced sound segment which is adjacent to the frame including or adjacent to the boundary, one frame including a discontinuous point in the vocal tract parameters which has been extracted at step S304, and one frame immediately previous or subsequent to the frame including the discontinuous point, as shown in a voiced sound segment of FIG. 18. As for the other frames, the frame thinning section 340 excludes two frames every three frames (i.e., the frame thinning section 340 selects consecutive two frames as excluded frames and the next one frame as a retained frame). As a result, at least one of frames which exist between a frame including a discontinuous point in the vocal tract parameters and a frame including a next discontinuous point is selected as a retained frame. Then, the frame thinning section 340 stores the number of excluded frames so as to be associated with a frame immediately previous to the excluded range (a segment where excluded frames consecutively exist).

[Step S106]

Then, the code generating section 140 associates a retained frame immediately previous to the excluded range and the number of excluded frames in the excluded range (thinning information) with each other.

[Step S107]

The code generating section 140 encodes the thinning information and the sound source parameters and the vocal tract parameters of the retained frames to generate codes.

As described above, the speech encoder 30 shown in FIG. 16 adaptively performs thinning of frames according to the state of speech in each frame in order to perform recording or transfer of data of a compressed data amount. The codes generated by the speech encoder 30 are decoded by the speech decoder 20 shown in FIG. 1.

<Effects>

In the speech encoder 30 according to embodiment 2 of the present invention, when frames are in an unvoiced sound segment, a frame including or adjacent to a boundary between voiced sound and unvoiced sound is selected as a retained frame. When frames are in a voiced sound segment, one frame including or adjacent to a boundary between voiced sound and unvoiced sound, one frame within the voiced sound segment which is adjacent to the frame including or adjacent to the boundary, one frame including a discontinuous point in the vocal tract parameters, and one frame immediately previous or subsequent to the frame including the discontinuous point. Thus, it is possible to reduce the deterioration in quality of a synthesized speech which may be caused in speech decoding.

<Variations>

Although in embodiment 2 the vocal tract parameter discontinuous point detecting section 330 extracts a discontinuous point in the vocal tract parameters based on the variation of the formant center frequency, the discontinuous point may be extracted using DP matching as described in embodiment 1.

Herein, among frames within a voiced sound segment, two frames adjacent to a boundary between voiced sound and unvoiced sound (one frame including or adjacent to a boundary between voiced sound and unvoiced sound and one frame within the voiced sound segment which is adjacent to the frame including or adjacent to the boundary) are selected as retained frames. However, any other number of frames may be selected as retained frames so long as they correspond to a speech waveform at a time within a 30 msec range from the boundary between voiced sound and unvoiced sound.

Although herein two frames every three frames are excluded by thinning within a voiced sound segment, the frames of the voiced sound segment may be thinned on any other basis so long as an interval between retained frames is 30 msec or smaller.

Although every other frames are excluded by thinning in an unvoiced sound segment, any other number of frames may be excluded so long as an interval between retained frames is 20 msec or smaller.

1. A speech encoder, comprising:
a speech analyzing section for estimating from a speech signal a vocal tract parameter set and a sound source parameter for each frame based on a predetermined speech generation model, the vocal tract parameter set including a plurality of vocal tract parameters;
a detection section for detecting a discontinuous point in each of the vocal tract parameters included in the vocal tract parameter set estimated by the speech analyzing section;
a thinning section for thinning frames except for a frame which includes the discontinuous point in the vocal tract parameter which is detected by the detection section; and
a code generating section for encoding a vocal tract parameter and a sound source parameter of a frame obtained after-the thinning process of the thinning section and thinning information which represents the number of frames excluded by the thinning section.

2. The speech encoder of claim 1, further comprising a determination section for determining voiced sound and unvoiced sound of the speech signal, wherein
the thinning section detects a frame which includes a boundary between the voiced sound and the unvoiced sound of the speech signal based on a determination result of the determination section and thins frames except for the frame which includes the boundary and the frame which includes the discontinuous point detected by the detection section.

3. The speech encoder of claim 2, wherein:
the thinning section thins frames except for the frame which includes the boundary between the voiced sound and the unvoiced sound, one or more frames subsequent to the frame which includes the boundary, and the frame which includes the discontinuous point; and
the one or more frames subsequent to the frame which includes the boundary correspond to a speech waveform at a point in a 30 msec range from the boundary.

4. The speech encoder of claim 1, wherein:
the thinning section detects a frame which includes a phoneme boundary of the speech signal based on phoneme label information about the speech signal and thins frames except for the frame which includes the phoneme boundary and the frame which includes the discontinuous point detected by the detection section.

5. The speech encoder of claim 4, wherein:
the thinning section thins frames except for the frame which includes the phoneme boundary, one or more frames subsequent to the frame which includes the phoneme boundary, and the frame which includes the discontinuous point; and
the one or more frames subsequent to the frame which includes the phoneme boundary correspond to a speech waveform at a point in a 30 msec range from the phoneme boundary.

6. The speech encoder of claim 4, wherein the thinning section thins frames except for the frame which includes the phoneme boundary, the frame which includes the discontinuous point, and a frame which includes a ½-point of the time length of each phoneme.

7. The speech encoder of claim 4, wherein the thinning section thins frames except for the frame which includes the phoneme boundary, the frame which includes the discontinuous point, and a frame which includes a maximum amplitude point of each phoneme.

8. The speech encoder of claim 1, wherein:
the vocal tract parameter set includes a plurality of vocal tract parameters;
the plurality of vocal tract parameters represent a vocal tract filter of the speech generation model;
the detection section establishes correspondence of the vocal tract parameter sets between two adjacent frames by DP matching; and with the two adjacent frames being referred to as frame A and frame B and the vocal tract parameters included in the vocal tract parameter set being referred to as F1, F2, . . . in increasing order of the center frequency of the vocal tract filter, the detection section determines that the two adjacent frames are considered to be continuous when the number of parameters included in a vocal tract parameter set of frame A is equal to the number of parameters included in a vocal tract parameter set of frame B, and the vocal tract parameters having the same number are made correspondent to each other between frame A and frame B, and when otherwise, the detection section detects a frame boundary between the two adjacent frames as the discontinuous point.

9. The speech encoder of claim 1, wherein the thinning section thins frames except for the frame which includes the discontinuous point and at least one of frames which exist between a frame including a certain discontinuous point and a frame including a discontinuous point next to the certain discontinuous point.

10. A speech decoder for synthesizing a speech signal based on the speech generation model using data encoded by the speech encoder of claim 1, comprising:
a detection section for detecting based on thinning information included in the encoded data the number of frames excluded by thinning from between a first frame of the encoded data and a second frame which comes next to the first frame;
an interpolation section for interpolating a sound source parameter and a vocal tract parameter of an excluded frame between the first and second frames based on the number of frames detected by the detection section, a sound source parameter and a vocal tract parameter of the first frame, and a sound source parameter and a vocal tract parameter of the second frame; and
a sound synthesizing section for applying a sound source parameter of the encoded data which is obtained after the interpolation performed by the interpolating section to a sound source model of the speech generation model to generate a sound source signal, constructing a vocal tract filter of the speech generation model based on a vocal tract parameter of the encoded data which is obtained after the interpolation performed by the interpolating section, and subjecting the generated sound source signal to the constructed vocal tract filter to generate a speech signal.

11. A speech encoding method, comprising the steps of:
estimating from a speech signal a vocal tract parameter set and a sound source parameter for each frame based on a predetermined speech generation model, the vocal tract parameter set including a plurality of vocal tract parameters;
detecting a discontinuous point in each of the vocal tract parameters included in the vocal tract parameter set estimated at the estimation step;
thinning frames except for a frame which includes the discontinuous point in the vocal tract parameter which is detected at the detection step; and
encoding a vocal tract parameter and a sound source parameter of a frame obtained after the thinning process at the thinning step and thinning information which represents the number of frames excluded at the thinning step.

12. The speech encoding method of claim 11, further comprising the step of determining voiced sound and unvoiced sound of the speech signal, wherein
at the thinning step, a frame which includes a boundary between the voiced sound and the unvoiced sound of the speech signal is detected based on a determination result of the determination step, and frames are thinned except for the frame which includes the boundary and the frame which includes the discontinuous point detected at the detection step.

13. The speech encoding method of claim 12, wherein:
at the thinning step, frames are thinned except for the frame which includes the boundary between the voiced sound and the unvoiced sound, one or more frames subsequent to the frame which includes the boundary, and the frame which includes the discontinuous point; and
the one or more frames subsequent to the frame which includes the boundary correspond to a speech waveform at a point in a 30 msec range from the boundary.

14. The speech encoding method of claim 11, wherein:
at the thinning step, a frame which includes a phoneme boundary of the speech signal is detected based on phoneme label information about the speech signal, and frames are thinned except for the frame which includes the phoneme boundary and the frame which includes the discontinuous point detected at the detection step.

15. The speech encoding method of claim 14, wherein:
at the thinning step, frames are thinned except for the frame which includes the phoneme boundary, one or more frames subsequent to the frame which includes the phoneme boundary, and the frame which includes the discontinuous point; and
the one or more frames subsequent to the frame which includes the phoneme boundary correspond to a speech waveform at a point in a 30 msec range from the phoneme boundary.

16. The speech encoding method of claim 14, wherein at the thinning step, frames are thinned except for the frame which includes the phoneme boundary, the frame which includes the discontinuous point, and a frame which includes a ½-point of the time length of each phoneme.

17. The speech encoding method of claim 14, wherein at the thinning step, frames are thinned except for the frame which includes the phoneme boundary, the frame which includes the discontinuous point, and a frame which includes a maximum amplitude point of each phoneme.

18. The speech encoding method of claim 11, wherein:
the vocal tract parameter set includes a plurality of vocal tract parameters;
the plurality of vocal tract parameters represent a vocal tract filter of the speech generation model;
at the detection step, correspondence of the vocal tract parameter sets between two adjacent frames is established by DP matching; and with the two adjacent frames being referred to as frame A and frame B and the vocal tract parameters included in the vocal tract parameter set being referred to as F1, F2, . . . in increasing order of the center frequency of the vocal tract filter, it is determined that the two adjacent frames are considered to be continuous when the number of parameters included in a vocal tract parameter set of frame A is equal to the number of parameters included in a vocal tract parameter set of frame B, and the vocal tract parameters having the same number are made correspondent to each other between frame A and frame B, and when otherwise, a frame boundary between the two adjacent frames is detected as the discontinuous point.

19. The speech encoding method of claim 11, wherein at the thinning step, frames are thinned except for the frame which includes the discontinuous point and at least one of frames which exist between a frame including a certain discontinuous point and a frame including a discontinuous point next to the certain discontinuous point.

20. A speech decoding method for synthesizing a speech signal based on the speech generation model using data encoded by the speech encoding method of claim 11, comprising the steps of:
detecting based on thinning information included in the encoded data the number of frames excluded by thinning from between a first frame of the encoded data and a second frame which comes next to the first frame;
interpolating a sound source parameter and a vocal tract parameter of an excluded frame between the first and second frames based on the detected number of frames, a sound source parameter and a vocal tract parameter of the first frame, and a sound source parameter and a vocal tract parameter of the second frame;
applying sound source parameters of respective frames of the encoded data which are obtained after the interpolation to a sound source model of the speech generation model to generate a sound source signal;
constructing a vocal tract filter of the speech generation model based on vocal tract parameters of the respective frames; and
subjecting the generated sound source signal to the constructed vocal tract filter to generate a speech signal.
